(19) United States
(12) Patent Application Publication
(10) Pub. No.: US 2021/0403773 A1
(43) Pub. Date: Dec. 30, 2021

(54) ADHESIVE COMPOSITION, ADHESIVE LAYER, SHEET AND TAPE

(71) Applicant: DIC Corporation, Tokyo (JP)

(72) Inventors: Sin Sou, Takaishi-shi (JP); Keiji Tsunashima, Takaishi-shi (JP); Mariko Tsunashima, Takaishi-shi (JP)

(73) Assignee: DIC Corporation, Tokyo (JP)

(21) Appl. No.: 17/289,038

(22) PCT Filed: Nov. 5, 2019
(86) PCT No.: PCT/JP2019/043211

§ 371 Date: Apr. 27, 2021

(30) Foreign Application Priority Data
Nov. 6, 2018 (JP) 2018-208909

(51) Int. Cl. C09J 133/08; C09J 133/26; C09J 133/06; C08K 5/00

(52) U.S. Cl. CPC C09J 133/08; C09J 133/26; C09J 133/064; C09J 2433/00; C09J 2301/122; C09J 2301/30; C09J 2427/006; C08K 5/0025

(57) ABSTRACT

An object of the present invention is to provide an adhesive capable of suppressing plasticizer transfer while maintaining high adhesive force. An adhesive composition of the present invention includes an acrylic polymer (A) and a crosslinking agent (B). The acrylic polymer (A) has units derived from a (meth)acrylic acid alkyl ester (a1), a (meth)acrylamide monomer (a2), and a carboxyl group-containing (meth)acrylic monomer (a3). The weight-average molecular weight of the acrylic polymer (A) is 1,500,000 or less, and the content of a tackifying resin is less than 10 parts by mass relative to 100 parts by mass of the acrylic polymer (A).

### TECHNICAL FIELD

The present invention relates to an adhesive composition.

### BACKGROUND ART

Adhesive sheets are used in a wide range from domestic to industrial fields of production and electrical insulating materials of various products, such as an electronic device, an automobile, and the like, the display/decoration field, etc. In particular, an adhesive sheet including soft PVC (vinyl chloride resin) as a substrate has high curved-surface adhesion and ink fixability and is thus used in a wide range of fields such as the display/decoration field and the like. In addition, soft PVC is used also for automobile wiring members because of its flexibility and electrical insulation and is often used also as an adherend of an adhesive tape.

An adhesive sheet or tape in contact with PVC, which has been known, has a problem of decrease in performance (peeling or lifting due to a decrease in adhesive force or a decrease in cohesive force) with time (in particular, under high temperature and high humidity) due to the plasticizer transfer from PVC to an adhesive layer. Therefore, Patent Literature 1 proposes an acrylic adhesive containing an acrylic resin and a plasticizer, the acrylic resin having a glass transition temperature of −20° C. or more (refer to Patent Literature 1). Also, Patent Literature 2 proposes an adhesive composition containing an acrylic copolymer, which is a copolymer of alkyl (meth)acrylate, a hydroxyl group-containing vinyl monomer, and a nitrogen-containing vinyl monomer, and at least one of an aliphatic isocyanate compound having two or more isocyanate groups and derivatives thereof (refer to Patent Literature 2).

However, these adhesives can exhibit plasticizer resistance, but fail to satisfy high adhesive force required for practical use.

### CITATION LIST

### Patent Literature

PTL 1: Japanese Unexamined Patent Application Publication No. 2016-188282

PTL 2: Japanese Unexamined Patent Application Publication No. 2016-108399

### SUMMARY OF INVENTION

### Technical Problem

The present invention has been achieved in consideration of the situation described above, and an object thereof is to suppress plasticizer transfer while maintaining high adhesive force.

### Solution to Problem

As a result of investigation, the inventors found that when specific acryl polymerization is used and a weight-average molecular weight is adjusted within a predetermined range, compatibility can be improved to improve uniformity of an adhesive layer, and consequently the plasticizer transfer can be suppressed while maintaining high adhesive force.

An adhesive composition of the present invention contains an acrylic polymer (A) and a crosslinking agent (B). The acrylic polymer (A) has units derived from a (meth)acrylic acid alkyl ester (a1), a (meth)acrylamide monomer (a2), and a carboxyl group-containing (meth)acrylic monomer (a3), and the weight-average molecular weight of the acrylic polymer (A) is 1,500,000 or less. The content of a tackifying resin is less than 10 parts by mass relative to 100 parts by mass of the acrylic polymer (A).

### Advantageous Effects of Invention

Even when a vinyl chloride resin is used as a substrate, an adhesive tape capable of suppressing the transfer to a plasticizer while maintaining high adhesive force can be provided by using an adhesive composition of the present invention.

### DESCRIPTION OF EMBODIMENTS

An adhesive composition of the present invention contains an acrylic polymer (A) and a crosslinking agent (B).

The acrylic polymer (A) has units derived from a (meth)acrylic acid alkyl ester (a1), a (meth)acrylamide monomer (a2), and a carboxyl group-containing (meth)acrylic monomer (a3).

The (meth)acrylic acid alkyl ester (a1) is, for example, a (meth)acrylic acid alkyl ester having an alkyl group bonded to an ester bond. The number of carbon atoms of the alkyl group is preferably 1 or more, more preferably 3 or more, and still more preferably 4 or more, and preferably 20 or less, more preferably 15 or less, still more preferably 12 or less, even still more preferably 10 or less, and particularly preferably 8 or less.

The (meth)acrylic acid alkyl ester (a1) preferably contains a (meth)acrylic acid alkyl ester (a1-1) having an alkyl group having a number of carbon atoms of 3 or more (preferably 4 or more) and being bonded to an ester bond. The content of the (meth)acrylic acid alkyl ester (a1-1) in the (meth)acrylic acid alkyl ester (a1) is preferably 50% by mass or more, more preferably 60% by mass or more, still more preferably 70% by mass or more, and preferably 100% by mass or less.

The (meth)acrylic acid alkyl ester (a1) preferably also contains a (meth)acrylic acid alkyl ester (a1-2) having an alkyl group having a number of carbon atoms of 2 or less and being bonded to an ester bond. When the (meth)acrylic acid alkyl ester (a1-2) is contained, the content thereof is preferably 1% by mass or more, more preferably 2% by mass or more, preferably 50% by mass or less, more preferably 40% by mass or less, and still more preferably 30% or less.

Examples of the alkyl group include linear alkyl groups such as a methyl group, an ethyl group, a n-propyl group, a n-butyl group, a n-pentyl group, a n-hexyl group, a n-heptyl group, a n-octyl group, a n-nonyl, and the like; branched chain alkyl groups such as an isopropyl group, an isobutyl group, an isopentyl group, a neopentyl group, an isohexyl group, an isoheptyl group, an isooctyl group, a 2-ethylhexyl group, and the like; and the like.

The (meth)acrylic acid alkyl ester (a1) is preferably an acrylic acid alkyl ester.

One or two or more types of the (meth)acrylic acid alkyl ester (a1) can be used, and examples thereof include methyl (meth)acrylate, ethyl (meth)acrylate, propyl (meth) acrylate, n-butyl(meth)acrylate, isobutyl (meth)acrylate, pentyl (meth)acrylate, hexyl (meth)acrylate, heptyl (meth)acrylate, n-octyl (meth)acrylate, isooctyl (meth)acrylate, 2-ethylhexyl (meth)acrylate, nonyl (meth)acrylate, and the like.

The content of the unit derived from the (meth)acrylic acid alkyl ester (a1) in the acrylic polymer (A) is preferably 50% by mass or more, more preferably 70% by mass or more, preferably 99% by mass or less, and more preferably 95% by mass or less.

In the (meth)acrylamide compound, examples of a group substituted to a nitrogen atom contained in an amide bond include a hydrogen atom, a hydrocarbon group (preferably an aliphatic hydrocarbon group), a group having —CO— substituted for —CH₂— contained in a hydrocarbon group (preferably an aliphatic hydrocarbon group) and/or having a hydroxyl group substituted for a hydrogen atom contained in a hydrocarbon group (preferably an aliphatic hydrocarbon group), and the like. When two or more groups are substituted to the nitrogen atom, the groups may be bonded to each other to form a ring containing the nitrogen atom.

The number of carbon atoms of a hydrocarbon group (preferably an aliphatic hydrocarbon group) substituted to a nitrogen atom contained in the amide bond is preferably 1 or more, preferably 10 or less, and more preferably 6 or less.

One or two or more types of the (meth)acrylamide monomer (a2) can be used. The (meth)acrylamide monomer may be any one of (meth)acrylamide, a N-monosubstituted (meth)acrylamide compound, and a N,N-disubstituted (meth) acrylamide compound.

One or two or more types of the (meth)acrylamide compound can be used, and examples thereof include (meth) acrylamide; N-monosubstituted (meth) acrylamide compounds such as N-isopropyl (meth)acrylamide, N-(1,1-dimethyl-3-oxobutyl) acrylamide, N-methylol (meth) acrylamide, N-methoxymethyl (meth) acrylamide, N-butoxymethyl (meth) acrylamide, N-(2-hydroxymethyl) acrylamide, N-(2-hydroxyethyl) acrylamide, and the like; N-disubstituted (meth)acrylamide compounds such as N-(meth)acryloyl morpholine, N-(meth)acryloyl piperidone, N-(meth)acryloyl piperidine, N-(meth)acryloyl pyrrolidine, N-(meth) acryloyl-4-piperidone, N,N-dimethyl (meth) acrylamide, N,N-diethyl (meth) acrylamide, N,N-methylene bis(meth)acrylamide, N,N-dimethylaminopropyl (meth)acrylamide, and the like; and the like.

In particular, the (meth)acrylamide monomer (a2) preferably contains a monomer represented by formula (1).

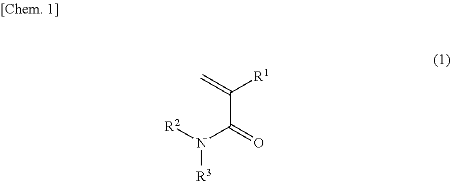

[In the formula (1), R¹ represents a hydrogen atom or a methyl group, R² and R³ each independently represent a hydrogen atom or a hydrocarbon group having a number of carbon atoms of 1 to 20, —CH₂— contained in the hydrocarbon group may be substituted by —CO— or —O—, a hydrogen atom contained in the hydrocarbon group may be substituted by a hydroxyl group, and R² and R³ may be bonded to each other to form a ring containing a nitrogen atom.]

One or two or more types of the hydrocarbon group represented by each of R² and R³ may be used, and examples thereof include a linear or branched chain saturated aliphatic hydrocarbon group; a linear or branched chain unsaturated aliphatic hydrocarbon group; and the like. In particular, a linear or branched chain saturated aliphatic hydrocarbon group is preferred, and a branched chain saturated aliphatic hydrocarbon group is more preferred. At least one of R² and R³ is preferably a hydrogen atom.

The (meth)acrylamide monomer (a2) preferably contains a (meth)acrylamide monomer (a2-1) having, as at least one of R² and R³, a group in which —CH₂— contained in a hydrocarbon group having a number of carbon atoms of 1 to 20 is substituted by —CO—. When the (meth)acrylamide monomer (a2-1) is contained, the content of the unit derived from the (meth)acrylamide monomer (a2-1) in the acrylic polymer (A) is preferably 3% by mass or more, more preferably 5% by mass or more, preferably 30% by mass or less, and more preferably 25% by mass or less.

The (meth)acrylamide monomer (a2) preferably also contains a (meth)acrylamide monomer (a2-2) having a hydrogen atom as one of R² and R³ and the hydrocarbon group as the other. When the (meth)acrylamide monomer (a2-2) is contained, the content of the unit derived from the (meth)acrylamide monomer (a2-2) in the acrylic polymer (A) is preferably 3% by mass or more, more preferably 5% by mass or more, preferably 30% by mass or less, and more preferably 25% by mass or less.

The (meth)acrylamide monomer (a2) preferably also contains a (meth)acrylamide monomer (a2-3) having the hydrocarbon groups as both R² and R³. When the (meth)acrylamide monomer (a2-3) is contained, the content of the unit derived from the (meth)acrylamide monomer (a2-3) in the acrylic polymer (A) is preferably 3% by mass or more, more preferably 5% by mass or more, preferably 30% by mass or less, and more preferably 25% by mass or less.

The content of the unit derived from the acrylamide monomer (a2) in the acrylic polymer (A) is preferably 1% by mass or more, preferably 40% by mass or less, more preferably 30% by mass or less, and still more preferably 25% by mass or less.

One or two or more types of the carboxyl group-containing (meth)acrylic monomer (a3) can be used, and examples thereof include unsaturated monocarboxylic acids such as (meth)acrylic acid, carboxyethyl (meth)acrylate, carboxypentyl (meth) acrylate, β-carboxyethyl (meth) acrylate, and the like.

The content of the unit derived from the carboxyl group-containing (meth)acrylic monomer (a3) in the acrylic polymer (A) is preferably 0.1% by mass or more, more preferably 0.5% by mass or more, still more preferably 1% by mass or more, preferably 20% by mass or less, more preferably 10% by mass or less, and still more preferably 7% by mass or less.

The acrylic polymer (A) may further contain a unit derived from a monomer (ax) other than the (meth)acrylic acid alkyl ester (a1), the (meth)acrylamide monomer (a2), and the carboxyl group-containing (meth)acrylic monomer (a3).

One or two or more types of the other monomer (ax) can be used, and examples thereof include a hydroxyl group-containing (meth)acrylic monomer; epoxy ring-containing (meth)acrylic monomers such as glycidyl (meth)acrylate and the like; aliphatic ring-containing (meth)acrylic monomers such as cyclohexyl (meth)acrylate and the like; aromatic vinyl monomers such as styrene, o-methylstyrene, m-methylstyrene, p-methylstyrene, ethylvinylbenzene, a-methylstyrene, p-methoxystyrene, p-tert-butylstyrene, p-phenylstyrene, o-chlorostyrene, m-chlorostyrene, p-chlorostyrene, para-hydroxystyrene, and the like; heterocycle-containing vinyl monomers such as N-vinylpyrrolidone, N-vinylcaprolactam, (meth)acryloyl morpholine, and the like; a monomer having two or more vinyl groups; (meth)acrylate compounds each having a functional group having a nitrogen atom (for example, an amino group, a monosubstituted amino group, a disubstituted amino group, a nitrile group, or the like), such as (meth)acrylonitrile, tert-butylaminoethyl (meth) acrylate, dimethylaminoethyl (meth)acrylate, diethylaminoethyl (meth)acrylate, and the like; and the like.

Examples of the hydroxyl group-containing (meth)acrylic monomer include a compound having a hydroxyl group bonded to an alkyl group of (meth)acrylic acid alkyl ester; (meth)acrylic acid polyalkylene glycol ester, and the like, preferred is a compound having a hydroxyl group bonded to an alkyl group of (meth)acrylic acid alkyl ester, and more preferred is a compound having a hydroxyl group bonded to an end of an alkyl group of (meth)alkyl acid alkyl ester.

The number of hydroxyl groups contained in the hydroxyl group-containing (meth)acrylic monomer is preferably 1.

Also, the hydroxyl group-containing (meth)acrylic monomer is preferably a hydroxyl group-containing acrylic monomer.

Examples of the acrylic acid alkyl ester includes the same compounds as the examples exemplified as the (meth)acrylic acid alkyl ester (a1).

One or two or more types of the hydroxyl group-containing (meth)acrylic monomer can be used, and examples thereof include hydroxyalkyl (meth)acrylates such as 2-hydroxyethyl (meth)acrylate, 2-hydroxypropyl (meth)acrylate, 2-hydroxybutyl (meth) acrylate, 4-hydroxybutyl (meth)acrylate, and the like; polyethylene glycol (meth)acrylate; and the like.

The content of the unit derived from the hydroxyl group-containing (meth)acrylic monomer in the acrylic polymer (A) is preferably 0.01% by mass or more, more preferably 0.02% by mass or more, still more preferably 0.03% by mass or more, preferably 10% by mass or less, more preferably 5% by mass or less, and still more preferably 1% by mass or less.

The content of the unit derived from the other monomer (ax) in the acrylic polymer (A) is preferably 0% by mass or more, more preferably over 0% by mass or more, still more preferably 0.01% by mass or more, preferably 20% by mass or less, more preferably 10% by mass or less, and still more preferably 5% by mass or less.

The weight-average molecular weight of the acrylic polymer (A) is preferably 100,000 or more, more preferably 200,000 or more, still more preferably 300,000 or more, preferably 1,000,000 or less, more preferably 900,000 or less, and still more preferably 800,000 or less.

In the present specification, the number-average molecular weight and weight-average molecular weight of the acrylic polymer (A) represent conversion values measured by gel permeation chromatography (GPC) using polystyrene as a standard sample.

In the adhesive composition of the present invention, the content of the acrylic polymer (A) in the nonvolatile content is preferably 30% by mass or more, more preferably 50% by mass or more, still more preferably 60% by mass or more, and preferably 100% by mass or less.

In the present specification, the nonvolatile content in the adhesive composition represents a portion obtained by removing the solvent component contained in the adhesive composition if required.

The acrylic polymer (A) can be produced by copolymerizing the (meth)acrylic acid alkyl ester (a1), the (meth)acrylamide monomer (a2), the carboxyl group-containing (meth)acrylic monomer (a3), and the other monomer (ax) used if required in the presence of a polymerization initiator.

For example, one or two or more thermal polymerization initiators can be used as the polymerization initiator, and examples thereof include peroxide initiators such as benzoyl peroxide, lauroyl peroxide, and the like; azo initiators such as azobisisobutyronitrile and the like; and the like.

The adhesive composition of the present invention contains a crosslinking agent (B), and one or two or more types of the crosslinking agent can be used. Examples thereof include an isocyanate crosslinking agent (preferably an aromatic isocyanate crosslinking agent), an epoxy crosslinking agent, an aziridine crosslinking agent, a polyvalent metal salt crosslinking agent, a metal chelate crosslinking agent, a keto-hydrazide crosslinking agent, an oxazoline crosslinking agent, a carbodiimide crosslinking agent, a silane crosslinking agent, a glycidyl (alkoxy)epoxy silane, crosslinking agent, and the like.

In particular, an isocyanate crosslinking agent (preferably, an aromatic isocyanate crosslinking agent), an epoxy crosslinking agent, an oxazoline crosslinking agent, a carbodiimide crosslinking agent, and a glycidyl (alkoxy)epoxy silane crosslinking agent are preferred, an isocyanate crosslinking agent (preferably, an aromatic isocyanate crosslinking agent), an epoxy crosslinking agent, and a carbodiimide crosslinking agent are more preferred, and an isocyanate crosslinking agent (preferably, an aromatic isocyanate crosslinking agent) is particularly preferred.

The content of the isocyanate crosslinking agent in the crosslinking agent (B) is preferably 30% by mass or more, more preferably 50% by mass or more, still more preferably 80% by mass or more, even still more preferably 90% by mass or more, and preferably 100% by mass or less.

The content of the crosslinking agent (B) relative to 100 parts by mass of the acrylic polymer (A) is preferably 0.1 parts by mass or more, more preferably 0.3 parts by mass or more, still more preferably 0.5 parts by mass or more, preferably 10 parts by mass or less, more preferably 7 parts by mass or less, and still more preferably 5 parts by mass or less.

The adhesive composition of the present invention preferably contains a solvent (D). One or two or more types of the solvent (D) can be used, and examples thereof include aromatic hydrocarbon solvents such as toluene, xylene, and the like; ester solvents such as ethyl acetate, butyl acetate, and the like; ketone solvents such as acetone, methyl ethyl ketone, and the like; aliphatic hydrocarbon solvents such as hexane and the like; and the like. In particular, an ester solvent is preferably contained.

The content of the ester solvent in the solvent (D) is preferably 50% by mass or more, more preferably 80% by mass or more, still more preferably 90% by mass or more, and preferably 100% by mass or less.

The content of the solvent (D) in the adhesive composition is preferably 10% by mass or more, more preferably 30% by mass or more, still more preferably 50% by as or more, preferably 90% by mass or less, more preferably 70% by mass or less, and still more preferably 65% by mass or less.

The content of the tackifying resin in the adhesive composition of the present invention is preferably decreased for maintaining low yellowing properties, and the content relative to 100 parts by mass of the acrylic polymer is preferably less than 10 parts by mass, more preferably 8 parts by mass or less, still more preferably 3 parts by mass or less, even still more preferably 1 part by mass or less, and preferably 0 parts by mass. By using the acrylic polymer (A) having a specific composition and weight-average molecular weight and using a configuration not containing the tackifying resin, it is possible to maintain high adhesive force and suppress plasticizer transfer even under high temperature/high humidity conditions while maintaining low yellowing of an adhesive layer.

The adhesive composition of the present invention may contain, as additives, a base (ammonia water or the like) or acid for adjusting pH, a foaming agent; a plasticizer; a softener, an antioxidant; glass or plastic-made fibers; fillers such as balloon, beads, a metal powder, and the like; coloring agents such as a pigment, a dye, and the like; a pH adjuster; a film forming aid; a leveling agent; a thickener; a water repellent; a defoaming agent; an acid catalyst; an acid generator; and the like.

The adhesive layer can be formed by coating the adhesive composition on a support and drying the composition. The support may be any one of substrates of a peel sheet, an adhesive sheet, and the like.

Usable examples of the coating method include methods such as a knife coater, a reverse coater, a die coater, a lip die coater, a slot die coater, a gravure coater, a curtain coater, and the like.

The thickness of the adhesive layer is preferably 5 μm or more, more preferably 10 μm or more, still more preferably 15 μm or more, preferably 100 μm or less, more preferably 70 μm or less, and still more preferably 50 μm or less.

An adhesive sheet or adhesive tape of the present invention has the adhesive layer and the substrate. The substrate may be in any one of a film shape, a sheet shape, a tape shape, a plate shape, a three-dimensional shape, and the like. Examples of the material of the substrate include plastics such as a polyester resin, a polypropylene resin, a polyethylene resin, a polyimide resin, a vinyl chloride resin, a urethane resin, and the like; rubber; a nonwoven fabric; a metal foil, paper, and the like, and plastics are preferred and a vinyl chloride resin is more preferred. Also, the substrate may have a smooth surface or an uneven surface of a fibrous substrate, a foam substrate, or the like.

The thickness of the substrate is preferably 0.1 μm or more and preferably 1,000 μm or less.

### EXAMPLES

The present invention is described in further detail below by giving examples.

### Synthesis Example 1

### <Synthesis of Acrylic Resin (A)>

In a reactor provided with a stirrer, a reflux condenser, a nitrogen inlet tube, and a thermometer, 580 parts by mass of butyl acrylate, 15 parts by mass of acrylic acid, 100 parts by mass of diacetone acrylamide (DAAM), 300 parts by mass of methyl acrylate, 5 parts by mass of 4-hydroxyethyl acrylate, and 1000 parts by mass of ethyl acrylate were charged and heated to 70° C. under stirring while nitrogen was blown in. One hour after, was added 10 parts (sold content of 5%) of a 2,2′-azobis(2-methylbutyronitrile) solution previously prepared by dissolving in ethyl acetate. Then, the resultant mixture was held for 8 hours under stirring at 70° C., and then the content was cooled and filtered with a wire netting having a mesh of 200, producing an acrylic resin (A) having a nonvolatile content of 50% by mass, a viscosity of 27,000 mPa·s, and a weight-average molecular weight of 600,000.

### Example 1

An acrylic adhesive composition was produced by stirring and mixing 1.2 parts by mass of a polyisocyanate-based crosslinking agent (Finetack curing agent D-40; manufactured by DIC Corporation) relative to 100 parts by mass of the acrylic resin (A) produced in Synthesis Example 1.

### Examples 2 to 7

An adhesive composition was produced by the same method as in Example 1 except that in Example 1, the acrylic monomers of the acrylic resin were changed as shown in Table 1.

The molecular weight is a value in terms of polystyrene measured under the following conditions.

Measurement apparatus: high-performance GPC apparatus (“HLC-8220GPC” manufacture by Tosoh Corporation)

Column: The following columns manufactured by Tosoh Corporation were connected in series and used.

“TSKgel GMH×L” (7.8 mm I. D.×30 cm)×4

Detector: RI (differential refractometer), RI temperature: 40° C.

Column temperature: 40° C.

Eluant: tetrahydrofuran (THF)

Flow rate: 1.0 mL/min

Injection amount: 100 μL

Concentration: (sample) 4 mg/mL tetrahydrofuran solution
(standard polystyrene) 1 mg/mL tetrahydrofuran solution

Standard sample: A calibration curve was formed by using the following standard polystyrene.

(Standard Polystyrene)

“Standard polystyrene A-500” manufactured by Tosoh Corporation

“Standard polystyrene A-1000” manufactured by Tosoh Corporation

“Standard polystyrene A-2500” manufactured by Tosoh Corporation

“Standard polystyrene A-5000” manufactured by Tosoh Corporation

“Standard polystyrene F-1” manufactured by Tosoh Corporation

“Standard polystyrene F-2” manufactured by Tosoh Corporation

“Standard polystyrene F-4” manufactured by Tosoh Corporation

“Standard polystyrene F-10” manufactured by Tosoh Corporation

“Standard polystyrene F-20” manufactured by Tosoh Corporation

“Standard polystyrene F-40” manufactured by Tosoh Corporation

“Standard polystyrene F-80” manufactured by Tosoh Corporation

“Standard polystyrene F-128” manufactured by Tosoh Corporation

“Standard polystyrene F-288” manufactured by Tosoh Corporation

“Standard polystyrene F-550” manufactured by Tosoh Corporation

“Standard polystyrene F-850” manufactured by Tosoh Corporation

### Comparative Examples 1 to 5

An adhesive composition was produced by the same method as in Example 1 except that the composition and molecular weight of the acrylic resin and the amount of the tackifier were changed as shown in Table 1.

(Comparative Example 4 could not be evaluated because coating was impossible due to high resin viscosity (molecular weight).)

[Comment: The comparative examples were corrected, and the numbers were corrected.]

### [Method for Forming Adhesive Film]

The adhesive composition produced in each of the examples and the comparative examples was coated on the surface of a polyethylene terephthalate film (mold release PET 25) having a thickness of 25 μm and a surface subjected to mold-release treatment so that the film thickness after solvent drying was 25 μm, and then the solvent was evaporated for 3 minutes in a dryer of 80° C. Then, a soft vinyl chloride substrate was laminated on the film.

### [Method for Measuring Adhesive Force]

The adhesive film formed by the method described above was cut in a width of 25 mm to form a test piece. A stainless plate formed of a BA (bright heat treatment after cold rolling) surface-finished SUS 304 stainless plate or a PP (polypropylene) plate was used as an adherend, and the test piece was bonded to the adherend by two reciprocations of a 2 kg roll. One hour after bonding, 180-degree peel strength was measured as adhesive force in an atmosphere of 23° C. and 50% RH. The results are shown in Table 1.

### [Method for Evaluating Plasticizer Resistance]

The retention rate of adhesive force was evaluated as follows. The results are shown in Table 1.

$$Rentention rate of adhesive force ( \% ) = \frac{\begin{matrix}Adhesive force of adhesive sheet after \\ storage at 60 ° C . and 90 \% RH for 4 days\end{matrix}}{\begin{matrix}Adhesive force of adhesive sheet \\ immediately after processing\end{matrix}} \times 100 \qquad [ Math . 1 ]$$

### [Method for Evaluating Yellowing Resistance]

The adhesive film formed by the method described above was cut in 5 cm×5 cm to form a test piece. The soft vinyl chloride substrate side was adhered to a light source part of a color meter, and the yellowing degree b* was measured under reflection measurement conditions. The results are shown in Table 1.

TABLE 1

| | | | | Example | | | | | | | Comparative Example | | | | |
|---|---|---|---|---|---|---|---|---|---|---|---|---|---|---|---|
| | | | | 1 | 2 | 3 | 4 | 5 | 6 | 7 | 1 | 2 | 3 | 4 | 5 |
| Composition | Acrylic | (a1) | 2EHA | | 76.0 | 19.5 | 72.5 | 70.0 | 38.0 | | 89.4 | 73.0 | 73.0 | 58.0 | 58.0 |
| (parts by | adhesive | | BA | 58.0 | | 50.0 | | | 40.0 | 91.2 | | | 15.0 | | 30.0 |
| mass) | | | MA | 30.0 | | 15.0 | 10.0 | | | 3.0 | | 15.0 | | 30.0 | |
| | | | CHA | | 15.0 | | | 22.0 | 10.0 | | | | | | |
| | | (a2) | DAAM | 10.0 | | | 15.0 | 1.5 | | | | | | 10.0 | 10.0 |
| | | | NIPAM | | 6.0 | | | | 10.0 | | | | | | |
| | | | DMAA | | | 10.0 | | | | 1.2 | | | | | |
| | | | NVP | | | | | | | | | 10.0 | | | |
| | | | DMAEA | | | | | | | | | | 10.0 | | |
| | | (a3) | AA | 1.5 | 3.0 | 5.0 | 2.0 | 6.0 | 1.5 | 4.0 | 10.0 | 1.5 | 1.5 | 1.5 | 1.5 |
| | | (ax) | 4HBA | 0.5 | | 0.5 | 0.5 | | 0.5 | 0.6 | 0.6 | | 0.5 | | 0.5 |
| | | | HEA | | 0.5 | | | 0.5 | | | | 0.5 | | 0.5 | |
| | | Solvent | Ethyl acetate | 100 | 100 | 100 | 100 | 100 | 100 | 100 | 100 | 100 | 100 | 100 | 100 |
| | Tackifying | Polymerized | A-100 | | | | | | | | | | | | 10 |
| | resin | rosin-based | | | | | | | | | | | | | |
| | | Rosin ester- | D-135 | | | | | | | | | | | | 20 |
| | | based | | | | | | | | | | | | | |
| | Crosslinking | Isocyanate- | D-40 | 1.2 | 1.2 | 1.2 | 1.2 | 1.2 | 1.2 | 1.2 | 1.2 | 1.2 | 1.2 | 1.2 | 1.2 |
| | agent | based | | | | | | | | | | | | | |

| Weight-average molecular weight (10000) | | | 59 | 35 | 54 | 68 | 85 | 87 | 56 | 50 | 62 | 62 | 160 | 86 |
|---|---|---|---|---|---|---|---|---|---|---|---|---|---|---|
| Adhesive force (initial) | [N/25 mm] | SUS | 16 | 16 | 15 | 14 | 11 | 13 | 12 | 15 | 11 | 12 | — | 15 |
| | | PP | 15 | 15 | 13 | 12 | 12 | 11 | 11 | 14 | 9 | 8 | — | 14 |
| Adhesive force after durability test | [N/25 mm] | SUS | 14 | 12 | 11 | 12 | 8 | 11 | 8 | 6 | 7 | 5 | — | 10 |
| | | PP | 13 | 13 | 11 | 11 | 8 | 9 | 9 | 4 | 5 | 4 | — | 10 |

| | | | | | | | | | | | | | |
|---|---|---|---|---|---|---|---|---|---|---|---|---|---|
| Plasticizer resistance | SUS | 88% | 75% | 73% | 84% | 73% | 85% | 68% | 40% | 64% | 42% | — | 68% |
| (adhesive force retention rate) | PP | 87% | 83% | 85% | 92% | 70% | 82% | 82% | 29% | 56% | 50% | — | 71% |
| Yellowing degree (b*) | | 0.5 | 0.4 | 0.5 | 0.5 | 0.5 | 0.4 | 0.6 | 0.5 | 0.5 | 0.5 | — | 5.5 |

In Table 1, BA represents n-butyl acrylate; MA, methyl acrylate; CHA, cyclohexyl acrylate; NIPAM, N-isopropyl acrylamide; DMAA, dimethyl acrylamide; NVP, N-vinylpyrrolidone; and DMAEA, dimethylaminoethyl acrylate. In addition, A-100 represents “Super Ester A-100” (manufactured by Arakawa Chemical Industries, Ltd.), and D-135 represents “Pensel D-135” (manufactured by Arakawa Chemical Industries, Ltd.).

Examples 1 to 7 are examples of the present invention and use the acrylic polymer including both the (meth)acrylamide monomer and the carboxyl group-containing (meth)acrylic monomer, and thus both monomers are considered to interact with each other in a hydrogen-bonding manner, thereby causing little plasticizer transfer from the vinyl chloride substrate.

On the other hand, Comparative Examples 1 to 4 are examples not containing the unit derived from the (meth)acrylamide monomer, and thus both high adhesive force and plasticizer transfer resistance could not be satisfied. Comparative Example 5 is an example using the acrylic polymer having a weight-average molecular weight exceeding 1,500,000, and thus coatability on the vinyl chloride substrate was unsatisfactory. Comparative Example 6 is an example using the tackifying resin at a content exceeding 10 parts by mass relative to 100 parts by mass of the acrylic polymer, and thus transparency of the adhesive layer was unsatisfactory.

1. An adhesive composition comprising:
an acrylic polymer (A) and a crosslinking agent (B),
wherein the acrylic polymer (A) has units derived from a (meth)acrylic acid alkyl ester (a1), a (meth)acrylamide monomer (a2), and a carboxyl group-containing (meth)acrylic monomer (a3);
the weight-average molecular weight of the acrylic polymer (A) is 1,500,000 or less; and
the content of a tackifying resin is less than 10 parts by mass relative to 100 parts by mass of the acrylic polymer (A).

2. The adhesive composition according to claim 1, wherein the (meth)acrylamide monomer (a2) contains a monomer represented by formula (1), 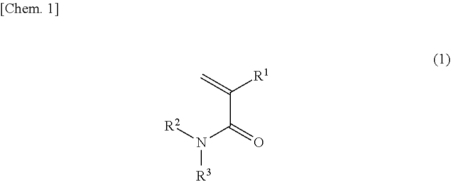
[in for formula (1), R¹ represents a hydrogen atom or a methyl group, R² and R³ each independently represent a hydrogen atom or a hydrocarbon group having a number of carbon atoms of 1 to 20, —CH₂— contained in the hydrocarbon group may be substituted by —CO— or —O—, a hydrogen atom contained in the hydrocarbon group may be substituted by a hydroxyl group, and R² and R³ may be bonded to each other to form a ring containing a nitrogen atom].

3. The adhesive composition according to claim 1, wherein the mass ratio [(a2)/(a3)] of the unit derived from the (meth)acrylamide monomer (a2) to the unit derived from the carboxyl group-containing (meth)acrylic monomer (a3) is 1.0 or more and 20 or less.

4. The adhesive composition according to claim 1, further comprising a solvent (D).

5. An adhesive layer formed of the adhesive composition according to claim 1.

6. A sheet or tape comprising a vinyl chloride resin substrate and the adhesive layer according to claim 5.

7. The adhesive composition according to claim 2, wherein the mass ratio [(a2)/(a3)] of the unit derived from the (meth)acrylamide monomer (a2) to the unit derived from the carboxyl group-containing (meth)acrylic monomer (a3) is 1.0 or more and 20 or less.

8. The adhesive composition according to claim 2, further comprising a solvent (D).

9. The adhesive composition according to claim 3, further comprising a solvent (D).

10. The adhesive composition according to claim 7, further comprising a solvent (D).

11. An adhesive layer formed of the adhesive composition according to claim 2.

12. An adhesive layer formed of the adhesive composition according to claim 3.

13. An adhesive layer formed of the adhesive composition according to claim 4.

14. An adhesive layer formed of the adhesive composition according to claim 7.

15. An adhesive layer formed of the adhesive composition according to claim 8.

16. An adhesive layer formed of the adhesive composition according to claim 9.

17. An adhesive layer formed of the adhesive composition according to claim 10.

18. A sheet or tape comprising a vinyl chloride resin substrate and the adhesive layer according to claim 11.

19. A sheet or tape comprising a vinyl chloride resin substrate and the adhesive layer according to claim 12.

20. A sheet or tape comprising a vinyl chloride resin substrate and the adhesive layer according to claim 13.
